(19) United States
(12) Patent Application Publication
(10) Pub. No.: US 2014/0181201 A1
(43) Pub. Date: Jun. 26, 2014

(54) APPARATUS AND METHOD FOR MANAGING LOCAL WIRELESS NETWORK GROUP

(71) Applicant: Pantech Co., Ltd., Seoul (KR)

(72) Inventor: Jae-Young CHOI, Paju-si (KR)

(73) Assignee: Pantech Co., Ltd., Seoul (KR)

(21) Appl. No.: 14/028,125

(22) Filed: Sep. 16, 2013

(30) Foreign Application Priority Data
Dec. 20, 2012 (KR) 10-2012-0149129

(51) Int. Cl. H04W 72/00

(52) U.S. Cl. CPC H04W 72/00
USPC 709/204

(57) ABSTRACT

An apparatus and a method for managing a local wireless network includes receiving, by a first group owner, capability information of a first client and a second client, selecting at least one of the first client and the second client as a second group owner based on the capability information, and replacing the first group owner with the second group owner as a group owner of the local wireless network if the first group owner is determined to be unavailable.

### CROSS-REFERENCE TO RELATED APPLICATION

This application claims the benefit under 35 U.S.C. §119(a) of Korean Patent Application No. 10-2012-0149129, filed on Dec. 20, 2012, the entire disclosure of which is incorporated herein by reference for all purposes.

### BACKGROUND

1. FIELD

The following description relates to a local wireless network technique capable of forming a group of local wireless network apparatuses.

2. Discussion of the Background

A variety of local wireless communication techniques (for example, WiFi Peer-to-Peer (P2P)), which are techniques capable of directly connecting devices by using local wireless communication, such as WiFi or Bluetooth®, to form groups of the devices and allow the devices to transmit data to each other, have attracted wide attention.

According to related-art local wireless communication techniques, one device or apparatus among a group of local wireless network apparatuses is chosen as a group owner that performs a role of an access point (AP), thereby connecting two or more local wireless network apparatuses in a P2P manner without an actual AP, which is an essential element of a conventional network. However, according to related-art local wireless communication techniques, a group of local wireless network apparatuses may undesirably break up in response to the group owner thereof leaving a predetermined local wireless communication range or becoming unable to properly perform its role due to, for example, a battery power shortage or poor network processing capability.

### SUMMARY

Exemplary embodiments of the present invention provide an apparatus and a method for managing a local wireless network.

Additional features of the invention will be set forth in the description which follows, and in part will be apparent from the description, or may be learned by practice of the invention.

Exemplary embodiments of the present invention provide a method for managing a local wireless network including receiving, by a first group owner, capability information of a first client and a second client; selecting at least one of the first client and the second client as a second group owner based on the capability information; and replacing the first group owner with the second group owner as a group owner of the local wireless network if the first group owner is determined to be unavailable.

Exemplary embodiments of the present invention provide a method for managing a local wireless network including receiving, by a first group owner, capability information of a first client and a second client; selecting the first client as a group sub-owner based on the capability information; and designating the group sub-owner as the second group owner if the first group owner is unavailable.

Exemplary embodiments of the present invention provide an apparatus to manage a local wireless network including an owner module to select a first group owner, to receive capability information from at least one of a first client and a second client, and to select the at least one of the first client and the second client as a second group owner based on the capability information; and a sub-owner module to determine whether the first group owner is unavailable, in which the owner module replaces the first group owner with the second group owner of the local wireless network if the sub-owner module determines that the first group owner is unavailable.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a local wireless network group according to an exemplary embodiment of the present invention.

FIG. 2 is a block diagram illustrating a local wireless network apparatus according to an exemplary embodiment of the present invention.

FIG. 3A and FIG. 3B are flowcharts illustrating a selection of a group owner and a group sub-owner according to exemplary embodiments of the present invention.

FIG. 4 is a flowchart illustrating a new group owner's succession to the role of a group owner according to an exemplary embodiment of the present invention.

FIG. 5A and FIG. 5B are flowcharts illustrating a group sub-owner's succession to the role of a group owner according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

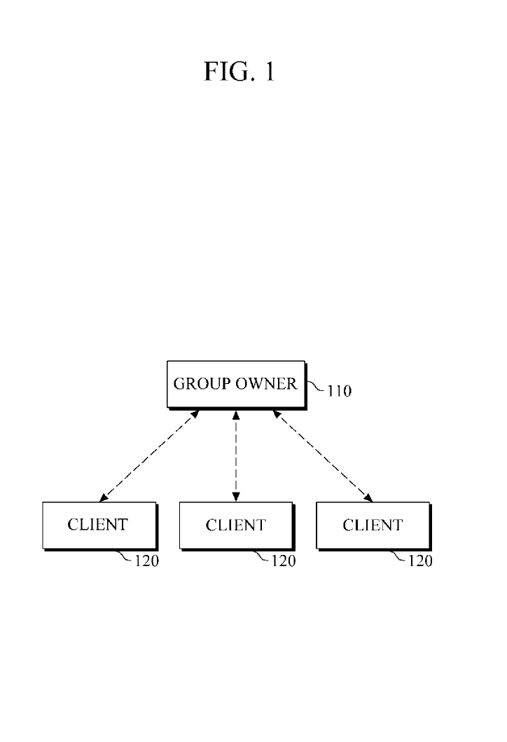

FIG. 1 is a block diagram illustrating a local wireless network group according to an exemplary embodiment of the present invention.

Referring to FIG. 1, at least two local wireless network apparatuses may be connected in a one-to-one or one-to-many manner, thereby forming a local wireless network group. Local wireless network apparatus, as used herein, may indicate an apparatus capable of forming a group and communicating with other apparatuses via local wireless communication without a network equipment, such as a base station or an access point (AP) for configuring or maintaining a network. The local wireless network apparatuses may use a local wireless network, for example, a WiFi Direct network. For example, the local wireless network apparatuses may form a group, including a group owner 110 and one or more clients 120, by using a WiFi Direct network. However, the local wireless network used by the local wireless network apparatuses is not limited to WiFi Direct, and instead, may adopt various other communication methods, such as Bluetooth®, ZigBee®, infrared (IR) communication, and the like to enable local wireless communication.

The local wireless network apparatuses may include various types of apparatuses (such as mobile phones, personal digital assistants (PDAs), printers, computers, and the like) capable of communicating with other apparatuses within a reference range thereof via local wireless communication.

The local wireless network apparatuses may form a local wireless network group through search and negotiation processes, and one apparatus among the local wireless network apparatuses may be selected as the owner of the local wireless network group, e.g., the group owner 110. The group owner 110 may serve as an AP that maintains the local wireless network group and allows the clients 120 to communicate with an external network 130. The clients 120 may include some or all the local wireless network apparatuses in the local wireless network group, except for the group owner 110.

According to aspects of the invention, the local wireless network group may have a group sub-owner, which may be designated to perform the role of the group owner if the group owner 110 become unavailable, unsuitable, less capable, or chooses to give up the role as the group owner. For example, the sub-owner may perform the role of the group owner if the group owner 110 unexpectedly leaves the local wireless network group. However, aspects of the invention are not limited thereto, such that the sub-owner may perform the role of the group owner in various circumstances. The group owner 110 may, without limitation, select one of the clients 120 as the group sub-owner prior to, during, or after the formation of the local wireless network group.

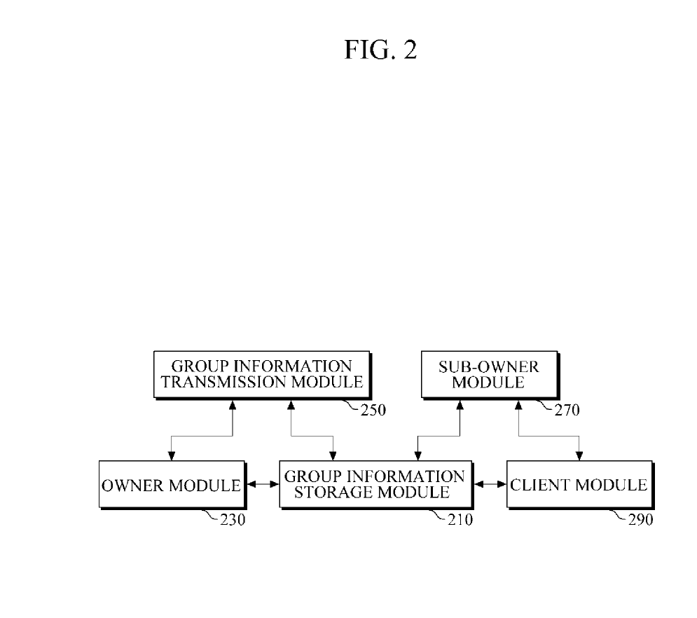

FIG. 2 is a block diagram illustrating a local wireless network apparatus according to an exemplary embodiment of the present invention.

Referring to FIG. 2, a local wireless network apparatus includes a group information storage module 210, an owner module 230 and a group information transmission module 250.

The group information storage module 210 may store group information, which may be used for maintaining a local wireless network group of the local wireless network apparatus. The group information may include, without limitation, at least one of: authentication information relating to an authentication performed between a group owner and one or more clients during the formation of the local wireless network group, for example, personal identification number (PIN) data entered by a user of the local wireless network apparatus via input device, such as a keypad, and data regarding a mutual authentication between the group owner and one or more clients, such as a simple setup process using a push button; a service set identifier (SSID), which may be a unique identifier of a local wireless network, included in the header of some or all packets transmitted via the local wireless network, and by which the local wireless network can be identified when the clients access the local wireless network; and various other information for maintaining the local wireless network group, such as a list of the clients, the identifiers and activation period of the clients, and the like.

When the owner module 230 selects one of the local wireless network apparatus to serve as a group owner, the owner module 230 may determine at various instances whether the group owner or group sub-owner is to be changed, and may select a new group owner or a new group sub-owner accordingly. More specifically, if a group owner or group sub-owner is to be changed, the owner module 230 may select a new group owner or a new group sub-owner from among the clients in the local wireless network group.

The owner module 230 may determine whether the group owner is to be changed according to a reference criterion. More specifically, the owner module 230 may determine whether the group owner is to be changed by comparing a current group owner's capabilities (such as remaining battery power, storage capacity, network processing speed, and the like) that can be calculated or the amount of content being used in the local wireless network group with a predefined reference value. For example, if the remaining battery power of the current group owner becomes less than 5% or the amount of data currently being input to the local wireless network group exceeds the current group owner's data handling capacity, the owner module 230 may determine and request a change of group owner.

According to aspects of the invention, the owner module 230 may select or designate a group sub-owner to replace the current group owner if the group owner become unavailable, unsuitable, less capable, or chooses to give up the role as the group owner. For example, the owner module 230 may select or designate the group sub-owner to replace the current group owner as a new group owner if the current group owner unexpectedly leaves the local wireless network group.

According to aspects of the invention, the owner module 230 may create a capability information table based on capability information received from one or more clients during the formation of the local wireless network group. The owner module 230 may select a client with a highest capability rating according to a reference criterion from among the clients listed in the capability information table as a group owner. The owner module 230 may select a client with a second highest capability rating as a group sub-owner. Further, the owner module 230 may rank the clients included in the local wireless network group based on their capability rating to determine which client is to be next in line to become a group owner and/or a group sub-owner.

Although exemplary embodiments are described as selecting a client with highest capability rating, aspects of the invention are not limited thereto, such that a client without the highest capability rating may be selected as a group owner or a group sub-owner based on other factors. Other factors may include, without limitation, security, reliability, duration in the local wireless network group, prior connection to the local wireless network group, and the like.

According to aspects of the invention, if a current or first group sub-owner leaves the local wireless network group or otherwise becomes unavailable or unsuitable, the owner module 230 may select a client with next highest capability rating in in view of reference criterion from among the clients listed in the capability information table as a new or second group sub-owner. Capability information may include, without limitation, a local wireless network apparatus' capabilities that can be calculated, such as remaining battery power, storage capacity, and network processing speed. However, aspects of the invention are not limited thereto, such that the owner module 230 may select or designate a group owner or a group sub-owner on other criteria. Other criteria may include, without limitation, reliability, duration, security, operating system, hardware specification, and the like.

According to aspects of the invention, if the local wireless network group suffers from frequent member changes, such as the joining of new clients or the leaving of existing clients, the owner module 230 may receive new capability information from the clients of the local wireless network group and may select a client with a highest capability rating as a new group owner or a group sub-owner with reference to the received capability information.

According to aspects of the invention, the owner module 230 may determine which capability information is to be referenced in selecting a group owner or a group sub-owner based on a reference set of performance conditions for a group owner or a group sub-owner. The owner module 230 may send a request to one or more clients to transmit the determined capability information. For example, a capability information request may be transmitted to a client using a signal, which may include in the “sub type” field of the frame thereof predetermined identification information (for example, a predefined value such as “1101”). More specifically, the owner module 230 may send a client a signal indicating that the signal is a capability information request signal. Further, the transmitted signal may indicate in the data field of the frame thereof which capability information is requested by a group owner to be transmitted by the client to the group owner. The capability information request, however, is not limited to the form set forth herein and may be implemented in various other forms.

According to aspects of the invention, a capability information request may be transmitted to one or more clients in synchronization with the activation period of one or more clients by referencing the group information present in the group information storage module 210.

According to aspects of the invention, if capability information is received from one or more clients, the owner module 230 may choose a group owner or a group sub-owner based on the received capability information. For example, if remaining battery power is set as the criterion for choosing a group owner or a group sub-owner, the owner module 230 may receive current battery power information from one or more clients and may select a client with a highest battery power as a group owner or a group sub-owner.

In another example, if storage capacity is set as the criterion for choosing a group owner or a group sub-owner, the owner module 230 may receive storage capacity information from one or more clients and may select a client with a largest storage capacity as a group owner or a group sub-owner.

According to aspects of the invention, the criterion for choosing a group owner or a group sub-owner may be set in advance, in real-time, or modified later. Further, the criterion for choosing a group owner or a group sub-owner may be obtained by combining two or more criteria, such as, for example, remaining battery power and network bandwidth.

According to aspects of the invention, the owner module 230 may choose one or more candidates for a group owner or a group sub-owner based on capability information received from each client and may send a request to the candidates to perform as a group owner or a group sub-owner. For example, the request to perform as a group owner or a group sub-owner may be sequentially transmitted to one or more clients in order of their capability ratings in view of a reference criterion. Further, the owner module 230 may select a client that accepts the request to perform as a group owner or a group sub-owner as a new group owner or a new group sub-owner. In addition, the clients may be set to automatically accept the request by the owner module 230 if a request to perform as a group owner or a group sub-owner is received.

According to aspects of the invention, if a group sub-owner is to be changed, the owner module 230 may select a client with a highest capability rating in terms of a predefined criterion as a new group sub-owner based on capability information received at the time of the formation of the corresponding local wireless network group. However, aspects of the invention are not limited thereto, such that capability information may be received in advanced or saved from a previous formation of a local wireless network group.

If one of the apparatuses in the local wireless network operates as a group owner, the group information transmission module 250 may transmit the group information present in the group information storage module 210 to any new group owner or group sub-owner selected by the owner module 230. If there are any updates in the group information of the local wireless network group after the selection of a group sub-owner, the group information transmission module 250 may transmit updated group information to the group sub-owner. For example, if a new client joins the local wireless network group or an existing client leaves the local wireless network group after the selection of a group owner or group sub-owner or in response to a change in the activation period of one or more clients in the local wireless network group after the selection of the group owner or group sub-owner, the group information of the local wireless network group may be updated accordingly. Further, the group information transmission module 250 may transmit the updated group information to the group owner or group sub-owner so that the group information present in the group owner or group sub-owner can be updated accordingly.

According to aspects of the invention, if the local wireless network apparatus is chosen as a new group owner, the owner module 230 may notify one or more clients in the local wireless network group of a change of group owner based on group information received from a previous group owner. However, aspects of the invention are not limited thereto, such that the group information may be received from a client in the local wireless network or an external source.

The local wireless network apparatus may also include a sub-owner module 270. If an apparatus among the local wireless network apparatuses serves as a group sub-owner, the sub-owner module 270 may monitor the movement of a current group owner and may perform a process of succeeding the group owner in response to the group owner leaving the local wireless network group without notice or otherwise becomes unavailable or unsuitable.

According to aspects of the invention, if no beacon signal is received from a current or first group owner within a reference period of time or reference number of requests, the sub-owner module 270 may determine that the current or first group owner has left the local wireless network group or otherwise has become unavailable. For example, if a beacon signal, which may be transmitted periodically by the current or first group owner, fails to be received more than a reference number of times or within a predefined period of time, the sub-owner module 270 may determine that the current group owner has left the local wireless network group or otherwise has become unavailable. In another example, the sub-owner module 270 may periodically send a signal to the current group owner, and may determine that the current group owner has left the local wireless network group or otherwise became unavailable if no response is received from the current group owner.

According to aspects of the invention, if the current or first group owner is determined to have left the local wireless network group or otherwise unavailable or unsuitable, the sub-owner module 270 may notify one or more clients in the local wireless network group of the unavailability of the current or first group owner with reference to the group information present in the group information storage module 210. For example, one or more clients in the local wireless network group may be notified of the unavailability of the current group owner at different times based on their activation period. In another example, if one or more clients in the local wireless network group continue to be activated, a notification signal or message indicating that the current group owner has left the local wireless network group or has otherwise become unavailable or unsuitable may be broadcast to some or all the clients in the local wireless network group. Such notification may be broadcasted according to a reference order or at the same time.

According to aspects of the invention, if a leaving group owner acknowledgement signal, which acknowledges the leaving of the current or first group owner, is received from one or more clients in the local wireless network group, the owner module 230 may notify one or more client in the local wireless network group that the current or first group owner will be replaced, and may replace the current or first group owner with a new or second group owner. In addition, a new group sub-owner may be designated when the new or second group owner replaces the first group owner. Further, one or more clients from which no leaving group owner acknowledgement signal has been received may be excluded from the local wireless network group.

The local wireless network apparatus may also include a client module 290. If a leaving group owner notice or a notice that the group owner has become unavailable is received from a group sub-owner, and a beacon signal is received from the leaving or first group owner within a reference period of time from the receipt of the leaving group owner notice, the client module 290 may notify the leaving or first group owner of the receipt of the leaving group owner notice. Further, if no beacon signal is received from the leaving or first group owner within the reference period of time from the receipt of the leaving group owner notice, the client module 290 may transmit a leaving group owner acknowledgement signal to the group sub-owner.

According to aspects of the invention, if a group owner replacement notice is received from a newly-selected group owner or a second group owner, the client module 290 may decide whether to maintain the network with the newly-selected or second group owner by sending a response to the group owner replacement notice to the newly-selected or second group owner within a reference period of time from the receipt of the group owner replacement notice.

The operations of the group information storage module 210, the owner module 230, the group information transmission module 250, the sub-owner module 270 and the client module 290 may be separately configured or one or more modules may be integrated together.

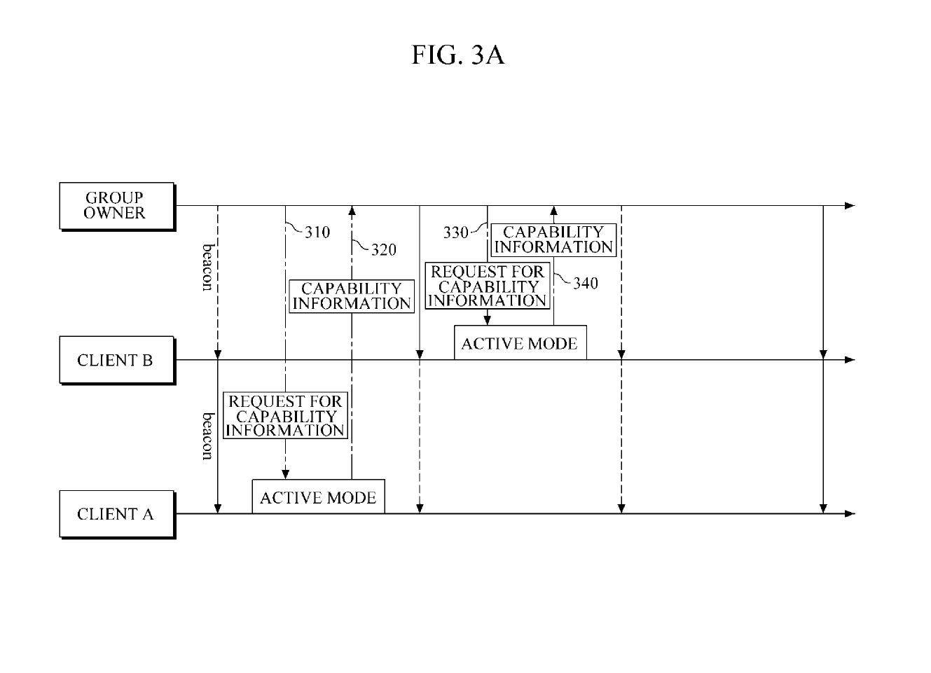

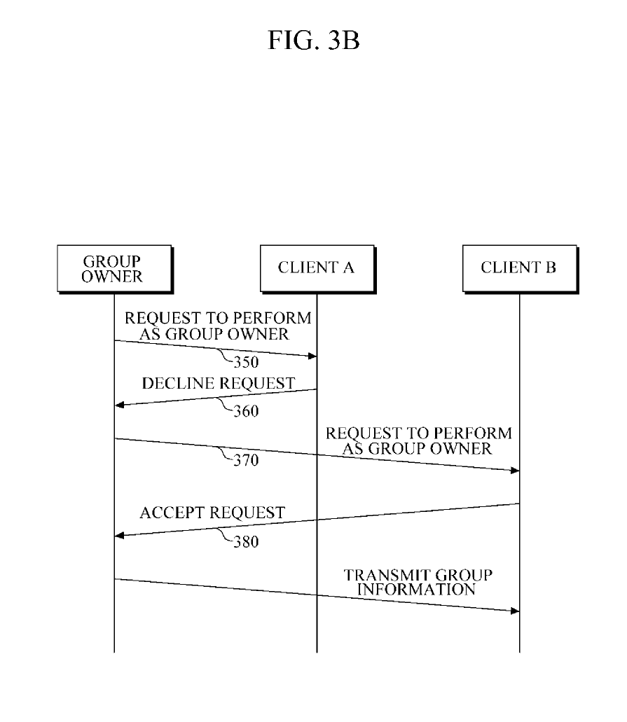

FIG. 3A and FIG. 3B are flowcharts illustrating selection of a group owner and a group sub-owner according to exemplary embodiments of the present invention.

Referring to FIG. 3A, if a group owner or group sub-owner is to be changed or replaced, a current group owner of a local wireless network group including client A and client B may send a request for capability information to client A (310) when client A is activated by referencing the group information present in the group information storage module 210. In response to the receipt of the request for capability information, client A transmits its capability information to the current group owner (320).

The current group owner sends a request for capability information to client B (330) at the time when client B is activated. In response to the receipt of the request for capability information, client B transmits its capability information to the current group owner (340).

According to aspects of the invention, the current group owner may send a request to client A and client B to perform or be designated as a group owner or a group sub-owner in order of their capability ratings in view of a reference criterion, which may be based on the capability information transmitted by client A and client B. More specifically, referring to FIG. 3B, the current group owner may send a request first to client A with a highest capability rating to perform as a group owner (350). Client A may determine whether to perform as a group owner and may transmit the results of the determination.

If client A declines the request to perform as a group owner (360), the current group owner may send a request to client B with a second highest capability rating (370) to perform as a group owner. If client B accepts the request to perform as a group owner (380), the current group owner may send the group information of the local wireless network group to client B (390).

Although exemplary embodiments are described as selecting a client with highest capability rating, aspects of the invention are not limited thereto, such that a client without the highest capability rating may be selected as a group owner or a group sub-owner based on other factors. Other factors may include, without limitation, security, reliability, duration in the local wireless network group, prior connection to the local wireless network group, and the like.

According to aspects of the invention, the user of client A or client B may decide whether client A or client B should perform as a group owner either in response to the receipt of a request to perform as a group owner from the current group owner or in advance.

According to aspects of the invention, a request for capability information and a request to perform as a group owner may be transmitted to one or more clients in accordance with the activation period of one or more clients. Further, the current group owner may broadcast a request for capability information and a request to perform as a group owner to one or more clients, and one or more clients may respond to the current group owner using their own identification numbers.

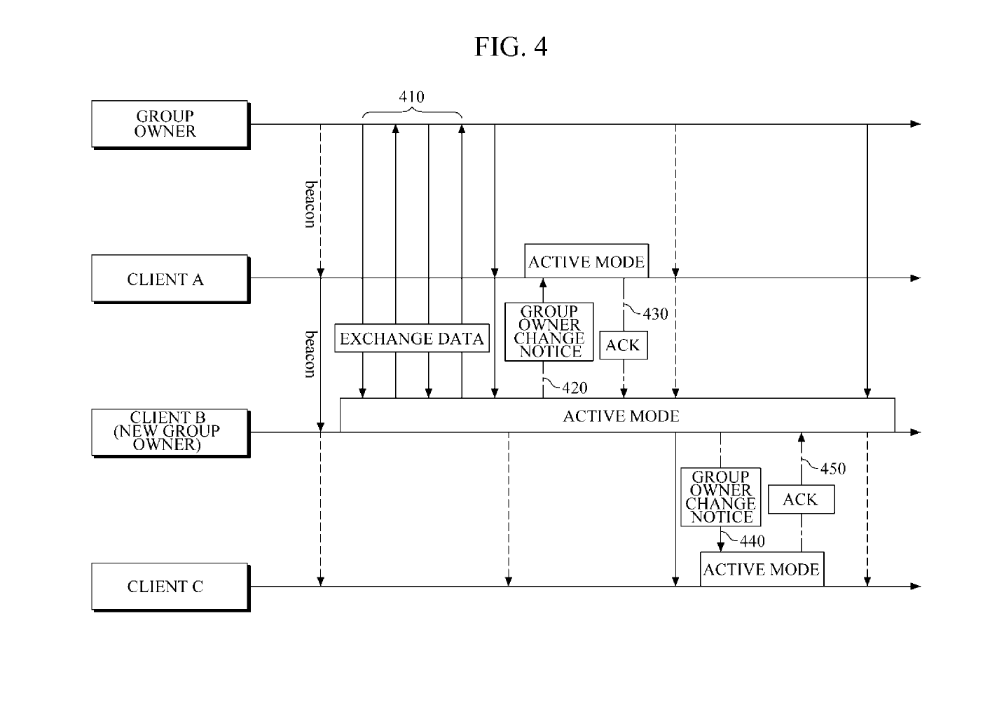

FIG. 4 is a flowchart illustrating a new group owner's succession to the role of a group owner according to an exemplary embodiment of the invention.

Referring to FIG. 4, in response to client B being chosen as a new group owner of a local wireless network group including client A, client B and client C, the new group owner receives group information of the local wireless network group from an existing group owner of the local wireless network group (410). The new group owner may notify the other clients in the local wireless network group that there has been a change of group owner with reference to the received group information. More specifically, the new group owner may send a group owner change notice to client A and C (420 and 440) in accordance with the activation periods of client A and client C.

When a response from client A and client C (430 and 450) are received after the transmission of the group owner change notice, client B may perform the role of the group owner of the local wireless network group.

According to aspects of the invention, a new group owner may exclude from its local wireless network group one or more clients that have failed to respond to a group owner change notice within a reference amount of time of the transmission of the group owner change notice or within a reference number of requests for a response. Even a client that has been excluded from its local wireless network group may be added back to its local wireless network group through a local wireless network formation process if the client is discovered by the group owner.

Further, the user of one or more clients may decide whether to respond to a group owner change notice.

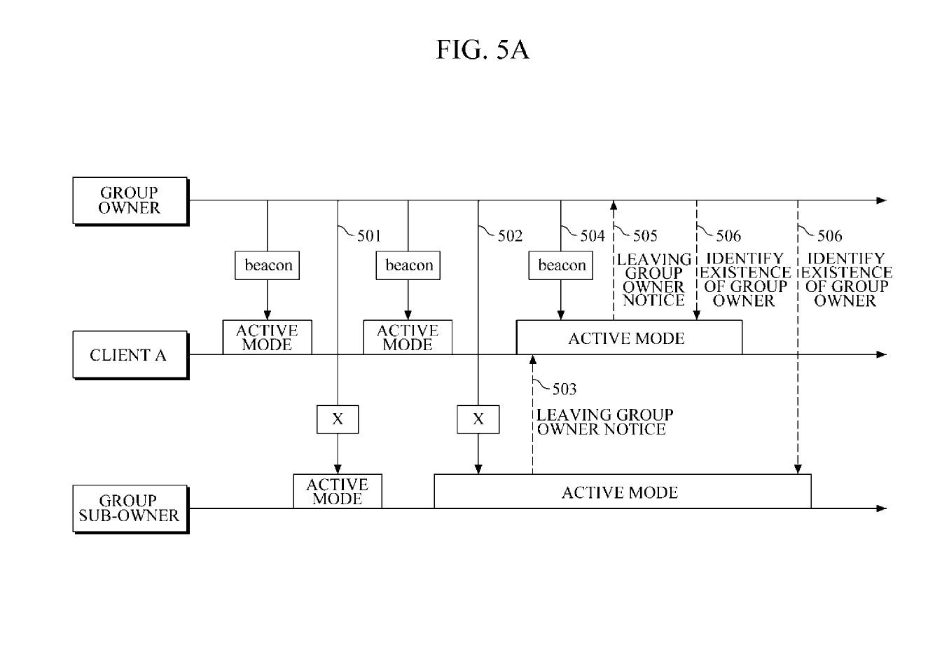

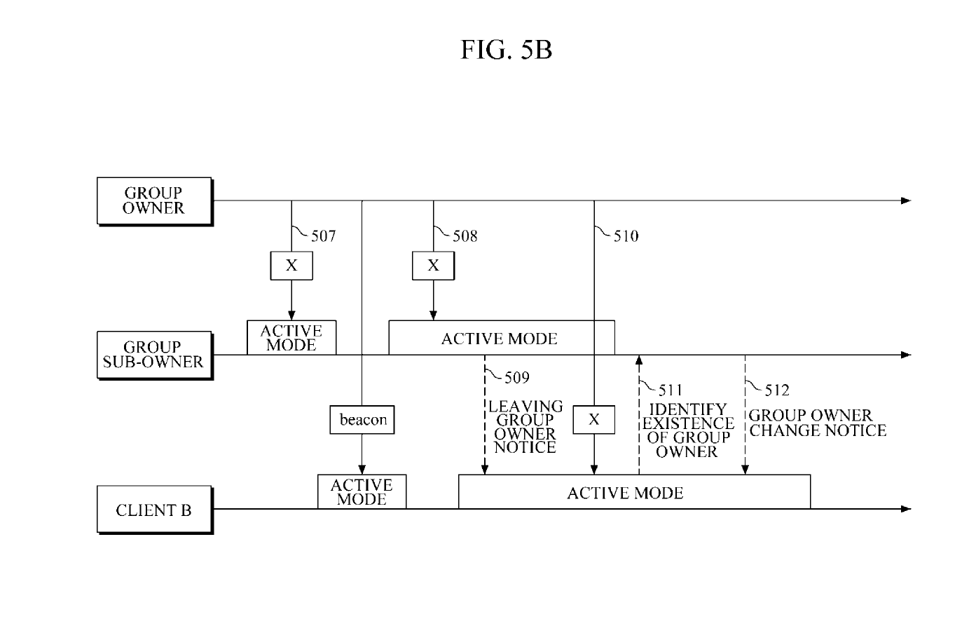

FIG. 5A and FIG. 5B are flowcharts illustrating a group sub-owner's succession to the role of a group owner according to exemplary embodiments of the present invention.

According to aspects of the invention, a local wireless network group may include a group owner and one or more clients. One of the clients in the local wireless network group may be chosen as a new group owner or a group sub-owner of the local wireless network group.

A group owner may transmit a beacon signal to one or more clients in accordance with their activation periods. If a beacon signal has failed to be received from a group owner within a reference number of requests, a group sub-owner may send a leaving group owner notice to one or more client in its local wireless network group and may replace the group owner. According to aspects of the invention, the beacon signal may be transmitted from the group owner to one or more clients according to reference intervals or a reference condition.

Referring to FIG. 5A, if a beacon signal has failed to be received from a group owner of a local wireless network group, including client A, two times in a row (501 and 502), a current group sub-owner of the local wireless network group may determine that the group owner has left the local wireless network group. Then, the group sub-owner may maintain its active mode, and may send a leaving group owner notice to client A (503). According to aspects of the invention, the beacon signal may be transmitted from the group owner to one or more clients according to at least one of a respective activation period, a reference interval, or a reference condition.

In response to the receipt of the leaving group owner notice from the group sub-owner, client A may determine whether the group owner has left the local wireless network group, while maintaining its active mode. As illustrated in FIG. 5A, since a beacon signal is received from the group owner after the receipt of a leaving group owner notice from the group sub-owner (504), client A may determine that the group owner has not left the local wireless network group, and may notify the group owner of the receipt of the leaving group owner notice (505).

The group owner may notify some or all clients in the local wireless network group of the group owner's continued existence, and may continue to maintain the local wireless network group as the group owner (506).

Referring to FIG. 5B, if a group sub-owner fails to receive a beacon signal from a group owner of a local wireless network group, including client B, two times in a row (507 and 508), the group sub-owner of the local wireless network group may determine that the group owner has left the local wireless network group, and may send a leaving group owner notice to client B (509). According to aspects of the invention, the beacon signal may be transmitted from the group owner to one or more clients according to at least one of a respective activation period, a reference interval, or a reference condition.

In response to the receipt of the leaving group owner notice, client B may determine that the group owner has left the local wireless network group because no beacon signal has been received from the group owner within a reference number of attempts or period of time after receiving the leaving group owner notice (510). Client B may transmit an acknowledgement signal acknowledging the leaving of the group owner to the group sub-owner (511).

In response to the receipt of the acknowledgement signal from client B, the group sub-owner may notify some or all clients in the local wireless network group of a change or unavailability of the current or first group owner. Further, the group sub-owner may replace the first group owner that is no longer available to become a second group owner (512). Although, not illustrated, client B may be designated as a second group sub-owner.

The exemplary embodiments illustrated in FIG. 5A and FIG. 5B are merely exemplary, and thus, aspects of the invention are not limited thereto. More specifically, in the exemplary embodiments illustrated in FIG. 5A and FIG. 5B, a group sub-owner may be configured to determine that a group owner has left a local wireless network group or otherwise unavailable in response to failure of receiving a beacon signal from the group owner two times in a row from the group owner. However, the group sub-owner may also be configured to determine that the group owner has left the local wireless network group in response to no beacon signal being received within a predefined amount of time or in response to a predefined number of failures to receive a beacon signal from the group owner.

According to aspects of the invention, a group sub-owner may send a leaving group owner notice more than once.

Further, in response to the receipt of a group owner change notice from a group sub-owner, one or more clients may decide whether to continue to communicate with a new group owner.

According to aspects of the invention, it may be possible to reduce a likelihood of a local wireless network group from breaking up even in response to a group owner becoming unable to perform its role or leaving the local wireless network group. As a result, it may be possible to save the time and resources that it takes to configure new local wireless network group.

In addition, according to aspects of the invention, it may be possible to maintain a local wireless network group even when a group owner leaves the local wireless network group and to continually provide network services with less interruption.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for managing a local wireless network, the method comprising:
receiving, by a first group owner, capability information of a first client and a second client;
selecting at least one of the first client and the second client as a second group owner based on the capability information; and
replacing the first group owner with the second group owner as a group owner of the local wireless network if the first group owner is determined to be unavailable.

2. The method of claim 1, further comprising:
notifying the at least one of the first client and the second client of the replacing of the first group owner with the second group owner.

3. The method of claim 1, further comprising:
selecting the at least one of the first client and the second client as a first group sub-owner based on the capability information,
wherein the first group sub-owner is designated as the second group owner if the first group owner is determined to be unavailable.

4. The method of claim 1, wherein the first group owner is determined to be unavailable if the at least one of the first client and the second client fails to receive a beacon message from the first group owner within a reference period of time or in response to a reference number of requests.

5. The method of claim 1, further comprising:
determining a capability rating of the at least one of the first client and the second client based on the capability information.

6. The method of claim 5, wherein a client with the highest capability rating is selected as a first group sub-owner.

7. The method of claim 5, wherein the at least one of the first client and the second client declines to be selected as the second group owner, and a client with the second highest capability rating is selected as the second group owner.

8. The method of claim 6, wherein the client with the highest capability rating declines to be selected as the first group sub-owner, and a client with the second highest capability rating is selected as the first group sub-owner.

9. The method of claim 1, further comprising:
receiving capability information of a third client when the third client joins the local wireless network;
comparing capability information of at least one of the first group owner, first client, the second client, and the third client; and
determining whether to designate the third client as the group owner of the local wireless network based on the comparing of the capability information.

10. A method for managing a local wireless network, the method comprising:
receiving, by a first group owner, capability information of a first client and a second client;
selecting the first client as a group sub-owner based on the capability information; and
designating the group sub-owner as the second group owner if the first group owner is unavailable.

11. The method of claim 10, further comprising:
transmitting, by the group sub-owner, a leaving group owner notice to the second client.

12. The method of claim 11, wherein, if the second client receives a beacon signal from the first group owner after the group sub-owner transmits the leaving group owner notice, the first group owner notifies of its availability to the group sub-owner.

13. The method of claim 11, wherein, if the second client fails to receive a beacon signal from the first group owner within a reference period of time after the group sub-owner transmits the leaving group owner notice, the group sub-owner transmits a group owner change notice to the second client.

14. The method of claim 11, wherein, if the second client fails to receive a beacon signal from the first group owner within a reference number of requests after the group sub-owner transmits the leaving group owner notice, the group sub-owner transmits a group owner change notice to the second client.

15. An apparatus to manage a local wireless network, the apparatus comprising:
an owner module to select a first group owner, to receive capability information from at least one of a first client and a second client, and to select the at least one of the first client and the second client as a second group owner based on the capability information; and
a sub-owner module to determine whether the first group owner is unavailable,
wherein the owner module replaces the first group owner with a second group owner of the local wireless network if the sub-owner module determines that the first group owner is unavailable.

16. The apparatus of claim 15, wherein the owner module selects the at least one of the first client and the second client as a group sub-owner based on the capability information,
wherein the first group sub-owner is designated as the second group owner if the sub-owner module determines that the first group owner is unavailable.

17. The apparatus of claim 15, wherein the sub-owner module determines that the first group owner is unavailable if the sub-owner module transmits a signal and fails to receive a response from the first group owner within a reference period of time.

18. The apparatus of claim 15, wherein the sub-owner module determines that the first group owner is unavailable if the sub-owner module fails to receive a response from the first group owner within a reference number of signals transmitted by the sub-owner module.

19. The apparatus of claim 15, wherein the sub-owner module transmits a leaving group owner notice to the at least one of the first client and the second client of the unavailability of the first group owner.

20. The apparatus of claim 19, further comprising:
a client module to transmit a leaving group owner acknowledgement signal to the sub-owner module if the client module does not receive a beacon message from the first group owner within a reference period of time or if a group owner replacement notice is received from the second group owner.
